(19) United States
(12) Patent Application Publication
(10) Pub. No.: US 2025/0264132 A1
(43) Pub. Date: Aug. 21, 2025

(54) CROWN-TYPE RETAINER FOR BALL BEARING, AND BALL BEARING

(71) Applicant: NSK Ltd., Tokyo (JP)

(72) Inventor: Masahito MATSUI, Kanagawa (JP)

(73) Assignee: NSK Ltd., Tokyo (JP)

(21) Appl. No.: 18/857,716

(22) PCT Filed: Mar. 7, 2023
(86) PCT No.: PCT/JP2023/008682

§ 371 Date: Oct. 17, 2024

(30) Foreign Application Priority Data
Apr. 20, 2022 (JP) 2022-069471

(51) Int. Cl. F16C 33/41; F16C 19/06

(52) U.S. Cl. CPC F16C 33/418; F16C 19/06; F16C 2240/70

(57) ABSTRACT

A crown cage for a ball bearing includes an annular main portion, pillar portions protruding in an axial direction at predetermined intervals in a circumferential direction from the main portion, and a pocket formed between the adjacent pillar portions and having a spherical concave surface having a spherical shape capable of holding a ball. The pillar portion includes a pair of claw portions having tip end portions arranged at intervals therebetween and a connection portion connecting the claw portions. An inlet portion having a width shorter than a diameter of the ball and for inserting the ball is provided between the tip end portions of the two adjacent claw portions configuring the pocket. A distance from an inner circumferential surface of the pocket to a center of the crown cage for a ball bearing is smaller than a radius of an inner circumferential surface of the pillar portion.

### TECHNICAL FIELD

The present invention relates to a crown cage for a ball bearing and a ball bearing.

### BACKGROUND ART

FIG. 30 is a cross-sectional view of a ball bearing 1 according to an example in the related art. Generally, the ball bearing 1 as shown in FIG. 30 is used to support a rotating portion of various rotary machines. The ball bearing 1 includes an inner ring 3 having an inner ring raceway 2 on an outer circumferential surface thereof, an outer ring 5 disposed concentrically with the inner ring 3 and having an outer ring raceway 4 on an inner circumferential surface thereof, and a plurality of balls 6 rollably disposed between the inner ring raceway 2 and the outer ring raceway 4.

Each ball 6 is rollably held by the cage 100. Outer circumferential edges of a pair of circular ring-shaped shield plates 7, 7 are respectively engaged with both axial end portions of the inner circumferential surface of the outer ring 5. The pair of shield plates 7, 7 prevent a lubricant such as grease present in a bearing space from leaking to the outside or prevent dust floating outside from entering the bearing space. Instead of the non-contact type shield plates 7, 7, a contact type seal may be used as a sealing device.

The cage 100 is a crown cage made of a resin. FIG. 31 is a perspective view of the cage 100 according to the example in the related art. FIG. 32 is a view of a portion of the cage 100 according to the example in the related art as viewed from a radially inner side. FIG. 33 is a top view of the portion of the cage 100 according to the example in the related art. As shown in FIGS. 31 to 33, the cage 100 includes an annular main portion 101, a plurality of pillar portions 102 protruding in an axial direction at predetermined intervals in a circumferential direction from the main portion 101, and pockets 103 each having a spherical shape formed between the adjacent pillar portions 102 and capable of holding the ball 6.

The pillar portion 102 has a pair of claw portions 105, 105 whose tip end portions are arranged at intervals. Since the two adjacent claw portions 105 and 105 configuring the pocket 103 hold the ball 6, the cage 100 is prevented from falling off in the axial direction from between the outer ring 5 and the inner ring 3. In the cage 100, as shown in FIG. 33, a distance L1 from the inner circumferential surface of the pocket 103 to the center of the cage 100 (the radius of the inner circumferential surface of the pocket 103) is equal to a radius r1 of the inner circumferential surface of the pillar portion 102 (the claw portion 105) (L1=r1).

In recent years, a rolling bearing (in particular, a ball bearing) that supports a rotating shaft of a motor has been required to be rotated at a high speed with the motorization of an automobile. To achieve the high-speed rotation, it is necessary to (i) prevent fatigue failure by suppressing centrifugal force expansion of the cage and reducing a stress generated at the bottom portion of the pocket, and (ii) avoid contact of the cage with the outer ring and the seal by suppressing deformation of the cage, thereby suppressing wear, vibration, and heat generation of the cage.

In the cage 100 in the related art as shown in FIGS. 31 to 33, the stress may act on the cage 100 by the centrifugal force during the high-speed rotation, and the cage 100 may be deformed toward an outer diameter side. In FIG. 30, a state in which the cage 100 is deformed is shown by a dashed line. In this case, the cage 100 may come into contact with the outer ring 5 (refer to a portion A in FIG. 30), the cage 100 may come into contact with the shield plate 7 (refer to a portion B in FIG. 30), and the cage 100 may wear, vibrate, or generate heat.

A cage described in Patent Literature 1 includes an annular base portion and an axial portion extending in an axial direction from the base portion. An outer diameter of the axial portion is smaller than an outer diameter of the base portion. The base portion is formed with a hole that communicates with a recessed area of the axial portion and penetrates in the axial direction. Accordingly, the amount of a material (that is, the mass of the cage) is reduced, and deformation in a radial direction induced during high-speed rotation is suppressed.

### CITATION LIST

### Patent Literature

Patent Literature 1: JP5436204B

### SUMMARY OF INVENTION

### Technical Problem

However, in order to meet the demand for higher-speed rotation, it is not enough to simply suppress deformation by reducing the weight of the cage or reduce the stress generated in the pockets, and it is necessary to suppress deformation of the cage caused by centrifugal force and further suppress stress by changing the shape which takes rigidity into amount. Accordingly, it is possible to avoid loss of the life at a high-stress portion generated in the pocket.

The present invention has been made in view of the above circumstances, and an object thereof is to provide a crown cage for a ball bearing and a ball bearing capable of suppressing deformation of the cage and capable of reducing stress.

### Solution to Problem

The above object of the present invention is achieved by the following configuration.

[1] A crown cage for a ball bearing includes:
an annular main portion;
a plurality of pillar portions protruding in an axial direction at predetermined intervals in a circumferential direction from the main portion; and
a pocket formed between the adjacent pillar portions and having a spherical concave surface having a spherical shape capable of holding a ball, wherein
the pillar portion includes a pair of claw portions having tip end portions arranged at intervals therebetween and a connection portion connecting the pair of claw portions,
an inlet portion having a width shorter than a diameter of the ball and for inserting the ball is provided between the tip end portions of the two adjacent claw portions configuring the pocket, and
a distance from an inner circumferential surface of the pocket to a center of the crown cage for a ball bearing is smaller than a radius of an inner circumferential surface of the pillar portion.

[2] A ball bearing includes:
an outer ring;
an inner ring;
a plurality of balls arranged between the outer ring and the inner ring; and
the crown cage for a ball bearing according to [1].

### Advantageous Effects of Invention

According to the crown cage for a ball bearing and the ball bearing of the present invention, deformation of the cage can be suppressed, and stress can be reduced.

### BRIEF DESCRIPTION OF DRAWINGS

FIG. 1 is a view of a portion of a cage according to a first embodiment as viewed from a radially inner side.

FIG. 2 is a top view of the portion of the cage according to the first embodiment.

FIG. 3 is a view of a portion of a cage according to a modification of the first embodiment as viewed from a radially inner side.

FIG. 4 is a top view of the portion of the cage according to the modification of the first embodiment.

FIG. 5 is a perspective view of a cage according to a second embodiment.

FIG. 6 is a top view of the cage according to the second embodiment.

FIG. 7 is a view of a portion of the cage according to the second embodiment as viewed from a radially inner side.

FIG. 8 is a top view of the portion of the cage according to the second embodiment.

FIG. 9 is a view of a portion of a cage according to a modification of the second embodiment as viewed from a radially inner side.

FIG. 10 is a top view of the portion of the cage according to the modification of the second embodiment.

FIG. 11 is a perspective view of a cage according to a third embodiment.

FIG. 12 is a top view of the cage according to the third embodiment.

FIG. 13 is a view of a portion of the cage according to the third embodiment as viewed from a radially inner side.

FIG. 14 is a top view of the portion of the cage according to the third embodiment.

FIG. 15 is a view of a portion of a cage according to a modification of the third embodiment as viewed from a radially inner side.

FIG. 16 is a top view of the portion of the cage according to the modification of the third embodiment.

FIG. 17 is a perspective view of a cage according to a fourth embodiment.

FIG. 18 is a top view of the cage according to the fourth embodiment.

FIG. 19 is a view of a portion of the cage according to the fourth embodiment as viewed from a radially inner side.

FIG. 20 is a top view of the portion of the cage according to the fourth embodiment.

FIGS. 21A, 21C, 21E and 21G are top views each showing a portion of a cage, and FIGS. 21B, 21D, 21F and 21H are views each showing the portion of the cage as viewed from the radially inner side. FIGS. 21A and 21B are a comparative example and show a cage shown in FIGS. 31 to 33 as a product in the related art, FIGS. 21C and 21D are an example and show the cage of the first embodiment shown in FIGS. 1 and 2, FIGS. 21E and 21F are an example and show the cage according to the modification of the first embodiment shown in FIGS. 3 and 4, and FIGS. 21G and 21H show a cage according to a comparative example.

FIGS. 22A, 22C, 22E and 22G are top views each showing a portion of a cage, and FIGS. 22B, 22D, 22F and 22H are views each showing the portion of the cage as viewed from the radially inner side. FIGS. 22A and 22B show a cage according to a comparative example, FIGS. 22C and 22D are an example and show the cage according to the second embodiment shown in FIGS. 5 to 8, FIGS. 22E and 22F are an example and show the cage according to the 10 modification of the second embodiment shown in FIGS. 9 and 10, and FIGS. 22G and 22H show a cage according to a comparative example.

FIGS. 23A, 23C, 23E and 23G are top views each showing a portion of a cage, and FIGS. 23B, 23D, 23F and 23H are views each showing the portion of the cage as viewed from the radially inner side. FIGS. 23A and 23B show a cage according to a comparative example, FIGS. 23C and 23D are an example and show the cage according to the third embodiment shown in FIGS. 11 to 14, FIGS. 23E and 23F are an example and show the cage according to the modification of the third embodiment shown in FIGS. 15 and 16, and FIGS. 23G and 23H are an example and show the cage according to the fourth embodiment shown in FIGS. 17 to 20.

FIG. 24, including Sections (a) to (d), shows a maximum principal stress distribution generated in the cages by a centrifugal force. The cages shown in Sections (a) to (d) of FIG. 24 correspond to the cages shown in FIGS. 23A, 23C, 23E and 23G, respectively.

FIG. 25 shows results of relative comparison of a maximum value of a maximum principal stress generated by a centrifugal force in each cage shown in FIG. 21A to FIG. 23H.

FIG. 26 is a cross-sectional view taken along a line A-A of FIG. 23G.

FIG. 27 shows a stress distribution when a centrifugal force is applied in the example of FIG. 23H.

FIG. 28 is a diagram for illustrating a model for analysis.

FIG. 29, including Sections (a) and (b), shows analysis results of a strain distribution of the cages.

FIG. 30 is a cross-sectional view of a ball bearing 1 according to an example in the related art.

FIG. 31 is a perspective view of a cage 100 according to the example in the related art.

FIG. 32 is a view of a portion of the cage 100 according to the example in the related art as viewed from a radially inner side.

FIG. 33 is a top view of the portion of the cage 100 according to the example in the related art.

### DESCRIPTION OF EMBODIMENTS

A crown cage for a ball bearing and a ball bearing according to an embodiment of the present invention will be described below with reference to the drawings.

### First Embodiment

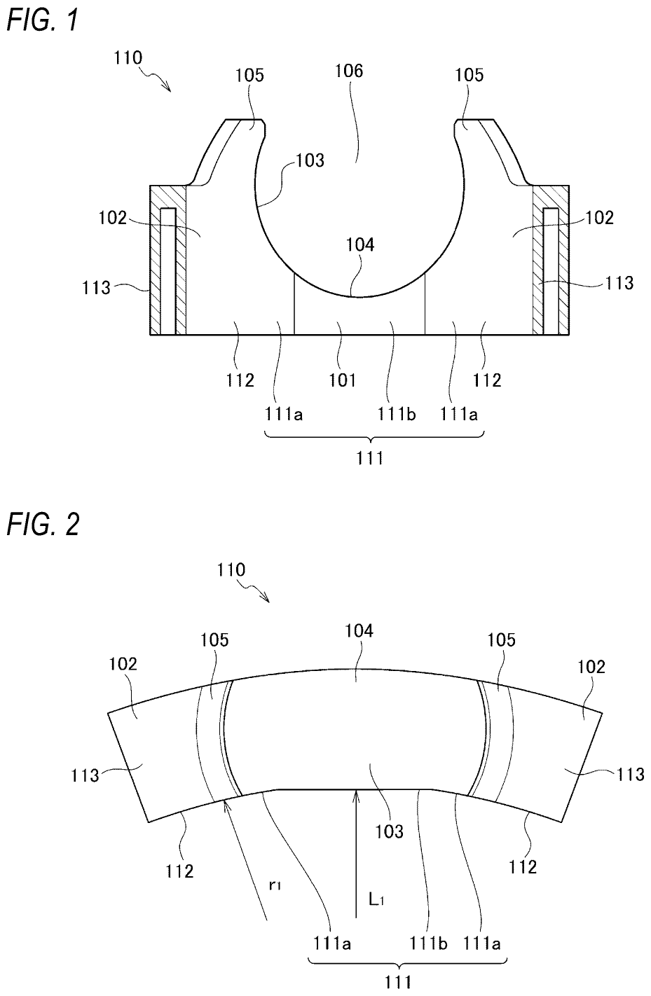

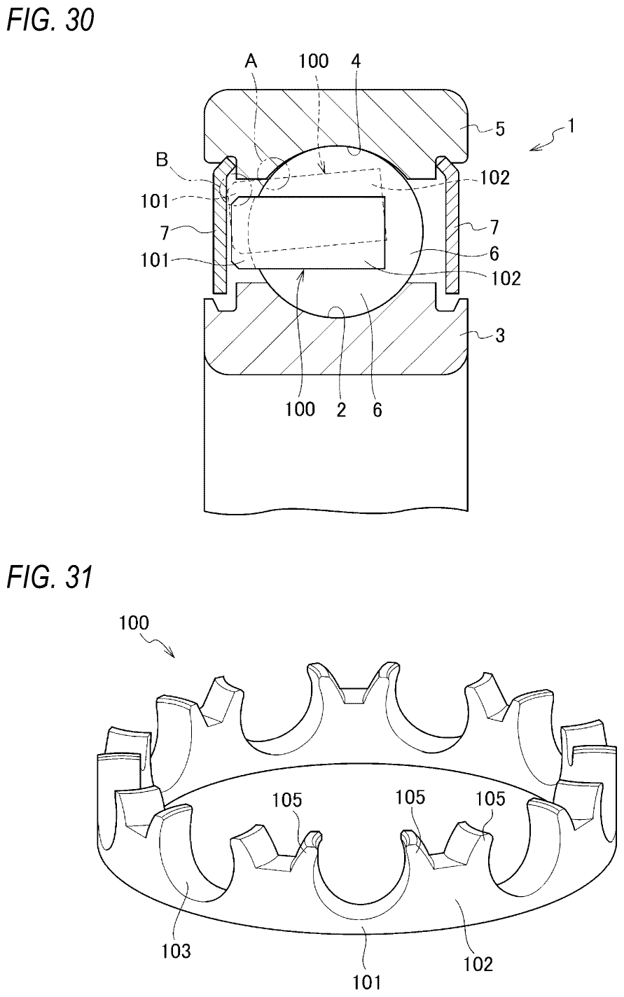

FIG. 1 is a view of a portion of a cage according to a first embodiment as viewed from a radially inner side. FIG. 2 is a top view of the portion of the cage according to the first embodiment. As shown in FIGS. 1 and 2, similarly to a cage 100 in the related art shown in FIGS. 31 to 33, a crown cage for a ball bearing (hereinafter, referred to as a “crown cage” or also simply referred to as a “cage”) 110 of the present embodiment can be applied to a ball bearing 1 shown in FIG. 30.

The crown cage 110 is made of a resin material such as nylon 46 (polyamide 46, PA46), nylon 66 (polyamide 66, PA66), polyamide 9T (PA9T), polyamide 10T (PA10T), L-PPS, PEEK, or the like, or another resin material. In order to improve the strength of the cage 110, a resin composition in which a fiber reinforcing material (carbon fiber, glass fiber, aramid fiber, or the like) is added in a number of 10% (for example, 10 to 50 wt %) may be used. Examples of a method for manufacturing the cage 110 include a method of injection molding using a mold, and a method of manufacturing with a 3D printer.

The crown cage 110 includes a substantially annular main portion 101, a plurality of pillar portions 102 protruding in an axial direction at predetermined intervals in a circumferential direction from the main portion 101, and pockets 103 each having a spherical shape formed between the adjacent pillar portions 102, 102 and capable of holding a ball 6 (see FIG. 30).

A plurality of spherical concave surfaces 104 each having a spherical shape are formed in the main portion 101 at predetermined intervals in the circumferential direction. The spherical concave surface 104 is formed over an entire radial width of the main portion 101, and configures the pocket 103.

The pillar portion 102 protrudes in the axial direction from the entire radial width of the main portion 101. The pillar portion 102 includes a pair of claw portions 105, 105 and a connection portion 113 connecting the pair of claw portions 105, 105.

Tip end portions of the pair of claw portions 105 and 105 are arranged at intervals in the circumferential direction. Further, an inlet portion 106 having a width shorter than the diameter of the ball 6 (see FIG. 30) and for inserting the ball 6 is provided between the tip end portions of the two adjacent claw portions 105, 105 configuring the pocket 103.

Circumferential surfaces of the two adjacent claw portions 105, 105 and the spherical concave surface 104 of the main portion 101 configures the pocket 103. The two circumferential surfaces and the spherical concave surface 104 are smoothly connected to each other to form a spherical concave surface of the pocket 103. A radius of curvature of the spherical concave surface of the pocket 103 is set to be larger than a radius of curvature of a rolling surface of the ball 6 (see FIG. 30).

As described above, since the plurality of pockets 103 are connected to each other by the main portion 101, when a centrifugal force is applied to the cage 110 during high-speed rotation or the like, the cage 110 falls to a radially outer side with the main portion 101 as a center.

In order to suppress the fall, an inner circumferential side of the pocket 103, where a high stress is generated (an inner circumferential side of the main portion 101 configuring the pocket 103), is formed to be thickened to the radially inner side. That is, as shown in FIG. 2, the distance L1 from an inner circumferential surface (inner circumferential surface of the main portion 101 configuring the pocket 103) 111 of the pocket 103 to a center of the cage 110 is smaller than the radius r1 of an inner circumferential surface 112 of the pillar portion 102 (L1<r1). Accordingly, the rigidity of the pocket 103 on the main portion 101 side is improved, and deformation of the crown cage 110 can be suppressed. On the other hand, in the cage 100 according to an example in the related art, as shown in FIG. 33, a distance from an inner circumferential surface of the pocket 103 to a center of the cage 100 is equal to the radius r1 of an inner circumferential surface of the pillar portion 102 (L1=r1).

In the illustrated example, the inner circumferential surface (inner circumferential surface of the main portion 101 configuring the pocket 103) 111 of the pocket 103 includes a pair of connection surfaces 111a, 111a positioned on both sides of the inner circumferential surface 111 in the circumferential direction and connected to the inner circumferential surface 112 of the pillar portion 102, and a convex surface 111b connecting inner side end portions of the pair of connection surfaces 111a, 111a in the circumferential direction to each other.

The pair of connection surfaces 111a, 111a are curved surfaces having substantially the same curvature as the inner circumferential surface 112 of the pillar portion 102. A distance from the pair of connection surfaces 111a, 111a to the center of the cage 110 is substantially equal to the radius r1 of the inner circumferential surface 112 of the pillar portion 102.

The convex surface 111b is a plane that protrudes to the radially inner side from the connection surface 111a and the inner circumferential surface 112 of the pillar portion 102. The shape of the convex surface 111b is not limited to a plane, and may be any shape, for example, an arc surface connecting the insides of the connection surfaces 111a, 111a, or a cylindrical surface shape as described below. The distance L1 from an inner circumferential surface of the convex surface 111b to the center of the cage 110 is smaller than the radius r1 of the inner circumferential surface 112 of the pillar portion 102.

A circumferential width of the convex surface 111b of the inner circumferential surface 111 is preferably set to a range in which the stress is particularly high when the centrifugal force is applied. That is, a range from about half an inner diameter of the pocket to a diameter position of the pocket is preferable.

As described above, according to the cage 110 of the present embodiment, deformation of the cage 110 is suppressed and the stress is reduced by thickening the inner circumferential side of the pocket 103, where a high stress is generated, to the radially inner side. As a result, the cage 110 can be prevented from coming into contact with the outer ring 5, the shield plate 7, or the like, and wear, vibration, heat generation, or the like of the cage 10 can be suppressed.

### Modification of First Embodiment

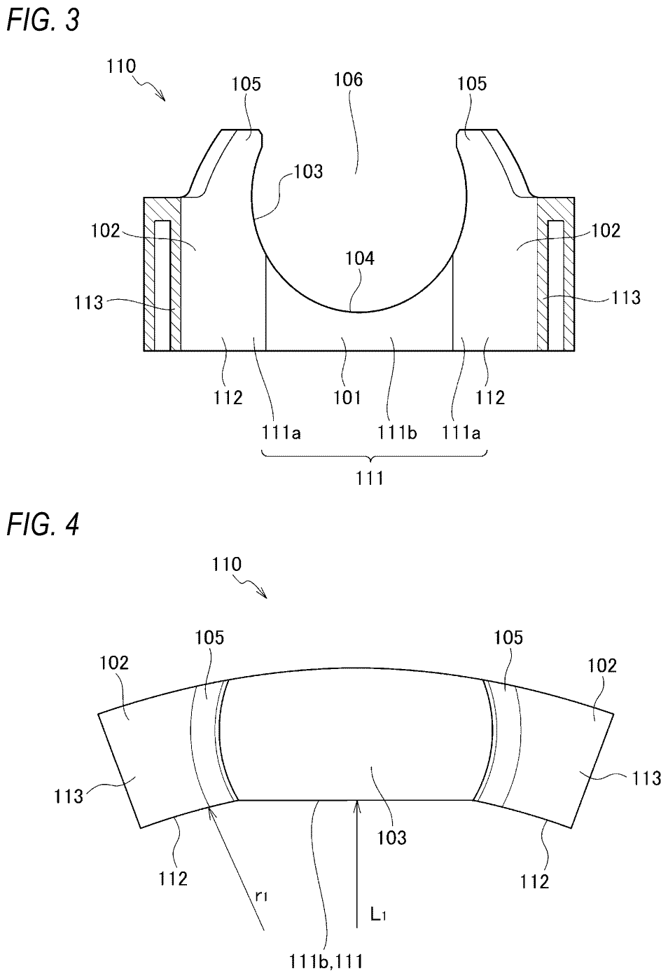

FIG. 3 is a view of a portion of a cage according to a modification of the first embodiment as viewed from a radially inner side. FIG. 4 is a top view of the portion of the cage according to the modification of the first embodiment. As shown in FIGS. 3 and 4, in the present modification, a circumferential width of the convex surface 111b of the inner circumferential surface 111 of the pocket 103 is set larger than that in the example of FIGS. 1 and 2. Specifically, both end portions in the circumferential direction of the convex surface 111b are arranged at substantially the same position in the circumferential direction with respect to tip end portions (inner side end portions in the circumferential direction) of the pair of claw portions 105, 105. Accordingly, the rigidity around the pocket 103 of the cage 110 can be further increased.

### Second Embodiment

Next, a crown cage for a ball bearing according to a second embodiment of the present invention will be described with reference to the drawings.

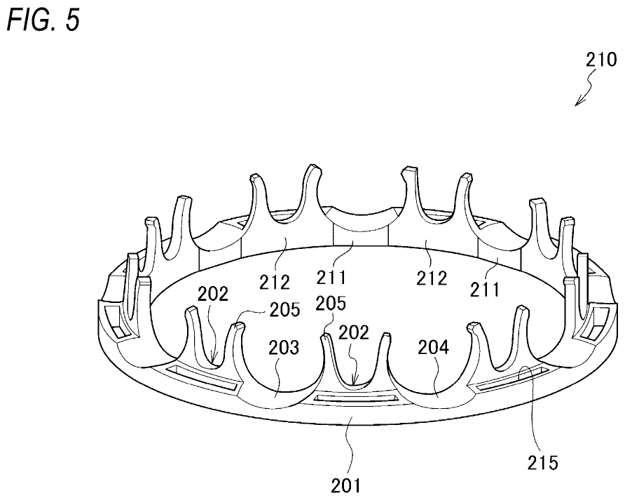

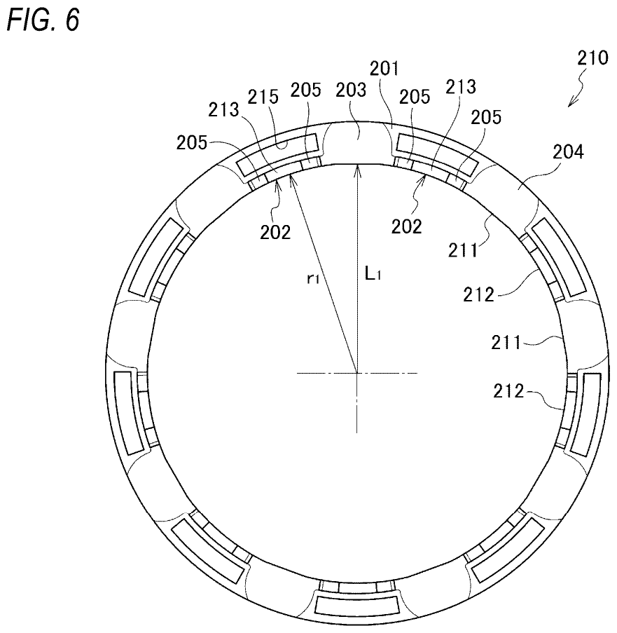

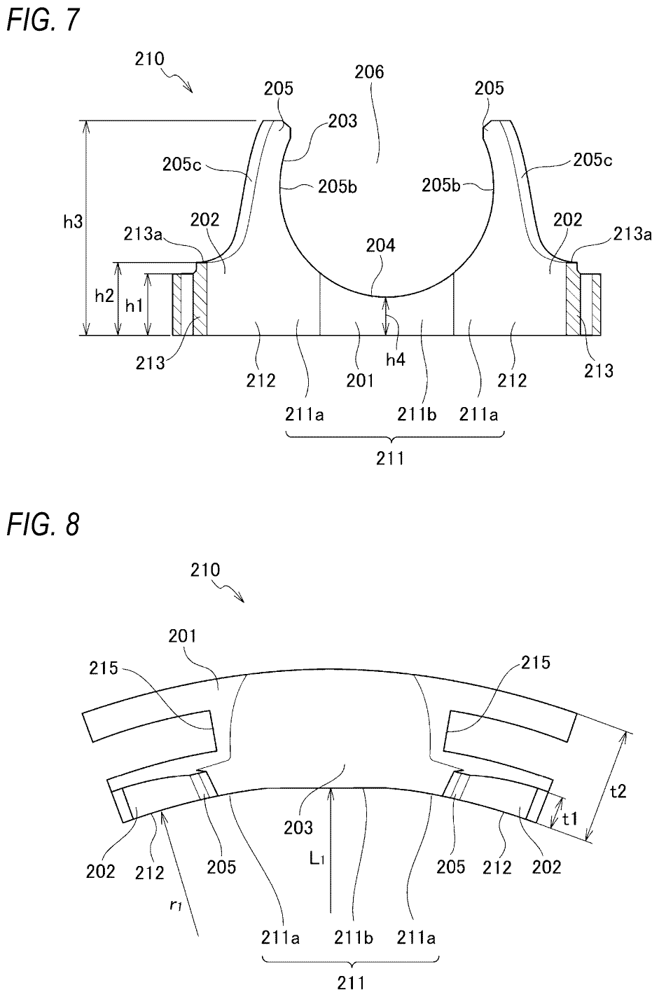

FIG. 5 is a perspective view of the cage according to the second embodiment. FIG. 6 is a top view of a cage according to the second embodiment. FIG. 7 is a view of a portion of the cage according to the second embodiment as viewed from a radially inner side. FIG. 8 is a top view of the portion of the cage according to the second embodiment.

A crown cage 210 of the present embodiment includes an annular main portion 201, a plurality of pillar portions 202 protruding in an axial direction at predetermined intervals in the circumferential direction from an upper surface of the main portion 201, and pockets 203 each having a spherical shape formed between the adjacent pillar portions 202, 202 and capable of holding the ball 6 (see FIG. 30).

A plurality of spherical concave surfaces 204 each having a spherical shape are formed at predetermined intervals in the circumferential direction on the upper surface of the main portion 201. The spherical concave surface 204 is formed over an entire radial width of the main portion 201, and configures the pocket 203.

The pillar portion 202 protrudes from a radially inner side portion of the upper surface of the main portion 201 in the axial direction. In addition, the upper surface of the main portion 201 is exposed to a radially outer side of the pillar portion 202. In the crown cage 110 (see FIGS. 1 to 4) of the first embodiment, since the pillar portion 102 protrudes in the axial direction from the entire radial width of the upper surface of the main portion 101, the pillar portion 202 of the second embodiment differs in this respect. That is, in the second embodiment, a configuration in which a region on the radially outer side of the pillar portion 202 (claw portions 205) is scraped is employed. That is, the pillar portion 202 of the second embodiment protrudes in the axial direction from only the radially inner side portion of the upper surface of the main portion 201, and is removed from a radially intermediate portion and a radially outer side portion of the upper surface of the main portion 201. Accordingly, the weight of the pillar portion 202, that is, the weight of the cage 210 is reduced, and deformation of the claw portion 205 due to the centrifugal force is suppressed even during high-speed rotation.

The pillar portion 202 includes the pair of claw portions 205, 205 and a connection portion 213 connecting the pair of claw portions 205, 205.

Tip end portions of the pair of claw portions 205, 205 are arranged at intervals in the circumferential direction.
An inlet portion 206 having a width shorter than the diameter of the ball 6 (see FIG. 30) and for inserting the ball 6 is provided between the tip end portions of the two adjacent claw portions 205, 205 configuring the pocket 203.

The claw portion 205 includes a circumferential first surface 205b of a spherical shape configuring the pocket 203 and a circumferential second surface 205c opposite the circumferential first surface 205b.

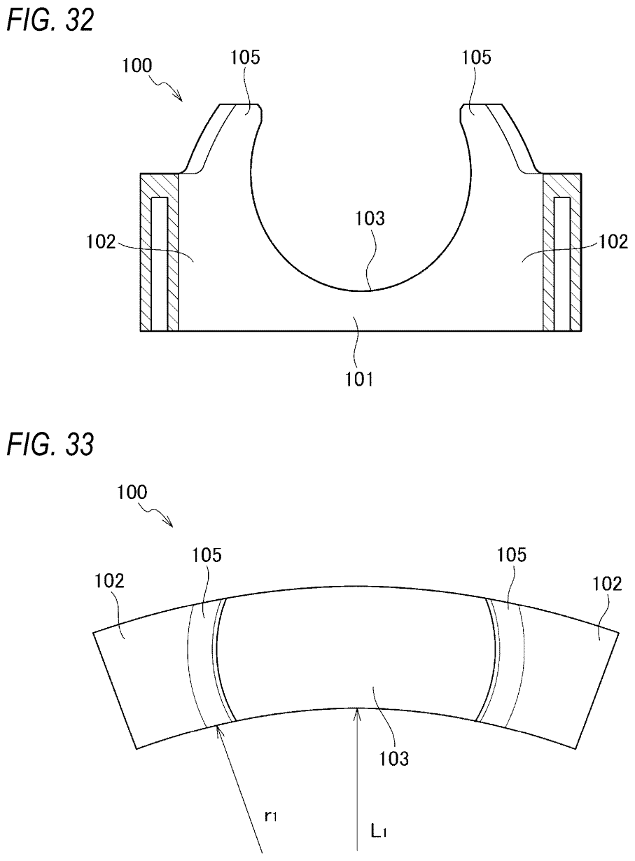

The circumferential second surfaces 205c, 205c of the pair of claw portions 205, 205 have curved shapes respectively and are smoothly connected to each other on an upper surface 213a of the connection portion 213. The upper surface 213a of the connection portion 213 corresponds to a substantially U-shaped bottom portion formed by the upper surface 213a and the pair of circumferential second surfaces 205c, 205c. The upper surface 213a (a bottom portion of the pair of circumferential second surfaces 205c, 205c) of the connection portion 213 is positioned slightly above (one side in the axial direction) the upper surface of the main portion 201. Accordingly, the bottom portion (the upper surface 213a of the connection portion 213) of the pair of circumferential second surfaces 205c, 205c is positioned below a center of the cage 210 in the axial direction (the other side in the axial direction), and forms a substantially U-shaped recessed portion. As shown in FIG. 32, in the crown cage 100 in the related art, an upper surface of a connection portion (a bottom portion of a pair of circumferential second surfaces) is positioned much higher than an upper surface of the main portion 101, and is positioned above a center of the cage 100 in the axial direction (one side in the axial direction).

As shown in FIG. 8, an outer diameter of the claw portion 205 is set to be smaller than an outer diameter of the main portion 201.
Further, a radial width t1 of the claw portion 205 is set to ½ or less of a radial width t2 of the main portion 201 {t1≤(t2)/2}.

As shown in FIG. 7, an axial width h2 from the upper surface 213a of the connection portion 213 of the pillar portion 202 to a bottom surface of the main portion 201 is set to ½ or less of an axial width h3 of the cage 210 {h2≤(h3)/2}. Further, an axial width h1 on a side of the connection portion 213 where the pillar portion 202 (the claw portion 205) is not present, that is, on the radially outer side, is also set to ½ or less of the axial width h3 {h1≤(h3)/2}. The axial width h1 is smaller than the axial width h2 (h1<h2).

If the axial widths h1, h2 are too small, the strength of the cage 210 may decrease, and thus the axial widths h1, h2 are preferably larger than an axial width h4 of the main portion 201 in a bottom portion of the pocket 203 (h1>h4, h2>h4).

The main portion 201 is provided with an opening portion 215 that opens in the axial direction between the adjacent pockets 203, 203. The opening portion 215 penetrates the bottom surface from the upper surface of the main portion 201 in the axial direction. The opening portion 215 is positioned on the radially outer side of the pillar portion 202 (the pair of claw portions 205, 205). That is, at least a portion of the opening portion 215 overlaps the pillar portion 202 (the pair of claw portions 205, 205) in the circumferential direction. Further, the claw portion 205 and the opening portion 215 are provided to be offset in the radial direction, and the opening portion 215 is positioned on the radially outer side of the claw portion 205. By providing the opening portion 215 in this way, the weight of the cage 210 is reduced.

When a width of the pillar portion 202 or the claw portion 205 of the cage 210 is reduced, there is a possibility that the strength will decrease, and there is a possibility that a resin does not flow and voids are generated when the cage 210 is manufactured by injection molding. A width of each portion of the cage 210 is preferably 1 mm or more.

As described above, since the plurality of pockets 203 are connected to each other by the main portion 201, when the centrifugal force is applied to the cage 210 at the time of high-speed rotation or the like, the cage 210 falls to the radially outer side with the main portion 201 as a center. In order to suppress the fall, an inner circumferential side of the pocket 203, where a high stress is generated (an inner circumferential side of the main portion 201 configuring the pocket 203), is formed to be thickened to the radially inner side.

That is, as shown in FIG. 8, the distance L1 from an inner circumferential surface 211 of the pocket 203 (an inner circumferential surface of the main portion 201 configuring the pocket 203) to a center of the cage 210 is smaller than the radius r1 of the inner circumferential surface 212 of the pillar portion 202.

In the illustrated example, the inner circumferential surface (inner circumferential surface of the main portion 201 configuring the pocket 203) 211 of the pocket 203 includes a pair of connection surfaces 211a, 211a positioned on both sides of the inner circumferential surface 211 in the circumferential direction and connected to the inner circumferential surface 212 of the pillar portion 202, and a convex surface 211b connecting inner side end portions of the pair of connection surfaces 211a, 211a in the circumferential direction to each other.

The pair of connection surfaces 211a, 211a are curved surfaces having substantially the same curvature as the inner circumferential surface 212 of the pillar portion 202. A distance from the pair of connection surfaces 211a, 211a to the center of the cage 210 is substantially equal to the radius r1 of the inner circumferential surface 212 of the pillar portion 202.

The convex surface 211b is a plane that protrudes to the radially inner side from the connection surface 211a and the inner circumferential surface 212 of the pillar portion 202. The shape of the convex surface 211b is not limited to a plane, and may be any shape, for example, a cylindrical surface shape as described below. The distance L1 from an inner circumferential surface of the convex surface 211b to the center of the cage 210 is smaller than the radius r1 of the inner circumferential surface 212 of the pillar portion 202 (L1<r1).

A circumferential width of the convex surface 211b of the inner circumferential surface 211 is preferably set to a range in which the stress is particularly high when the centrifugal force is applied. That is, a range from about half an inner diameter of the pocket to a diameter position of the pocket is preferable.

As described above, according to the cage 210 of the present embodiment, the weight of the cage 210 is reduced, the rigidity of the pocket 203 is improved, and the deformation and the stress caused by the centrifugal force during the high-speed rotation can be suppressed. As a result, the cage 210 can be prevented from coming into contact with the outer ring 5, the shield plate 7, or the like, and wear, vibration, heat generation, or the like of the cage 210 can be suppressed.

### Modification of Second Embodiment

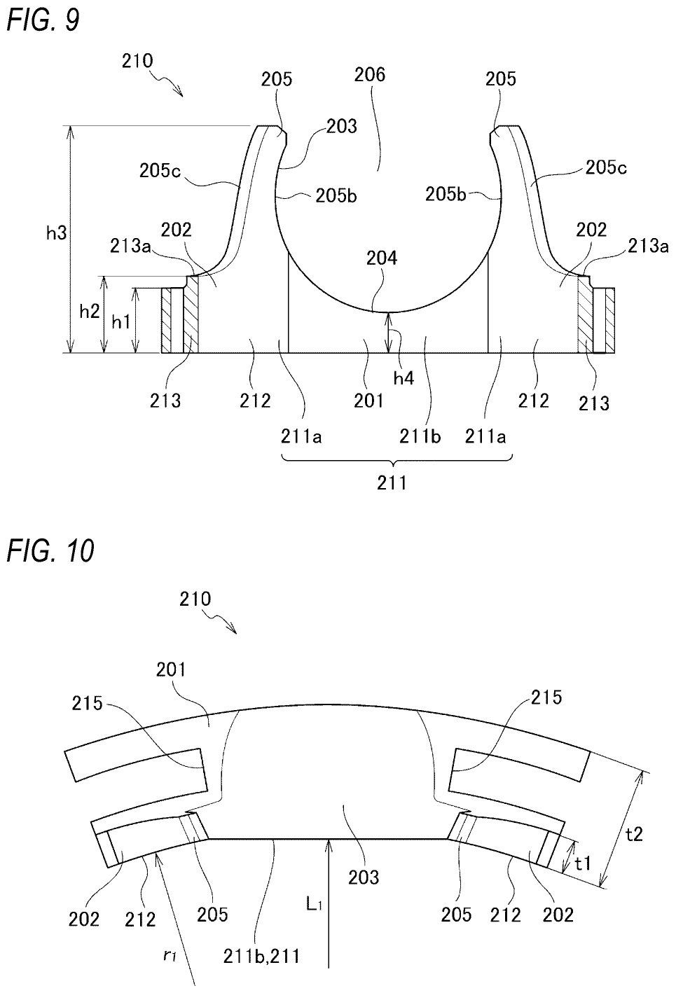

FIG. 9 is a view of a portion of a cage according to a modification of the second embodiment as viewed from a radially inner side. FIG. 10 is a top view of the portion of the cage according to the modification of the second embodiment. As shown in FIGS. 9 and 10, in the present modification, a circumferential width of the convex surface 211b of the inner circumferential surface 211 of the pocket 203 is set larger than that in the example of FIGS. 5 to 8. Specifically, both end portions in the circumferential direction of the convex surface 211b are arranged at substantially the same position in the circumferential direction with respect to tip end portions (inner side end portions in the circumferential direction) of the pair of claw portions 205, 205. Accordingly, the rigidity around the pocket 203 of the cage 210 can be further increased.

### Third Embodiment

Next, a crown cage for a ball bearing according to a third embodiment of the present invention will be described with reference to the drawings.

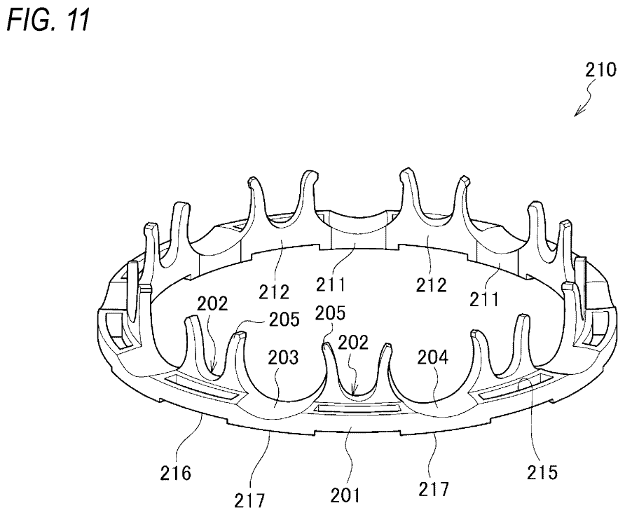

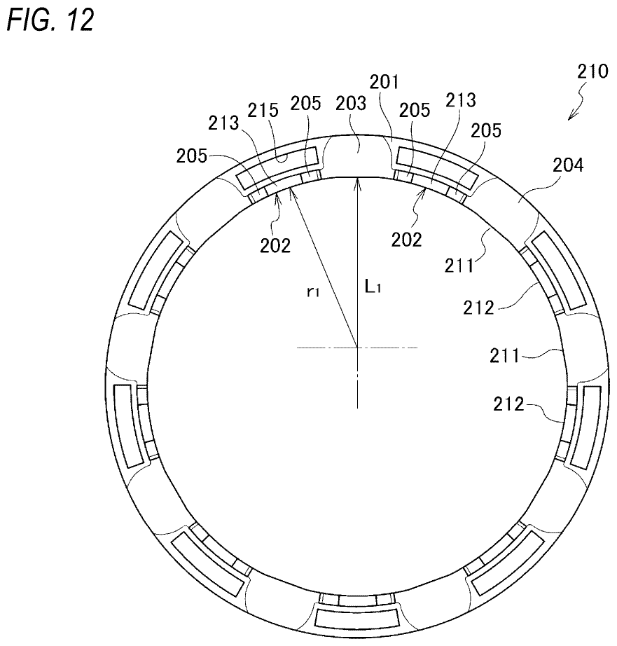

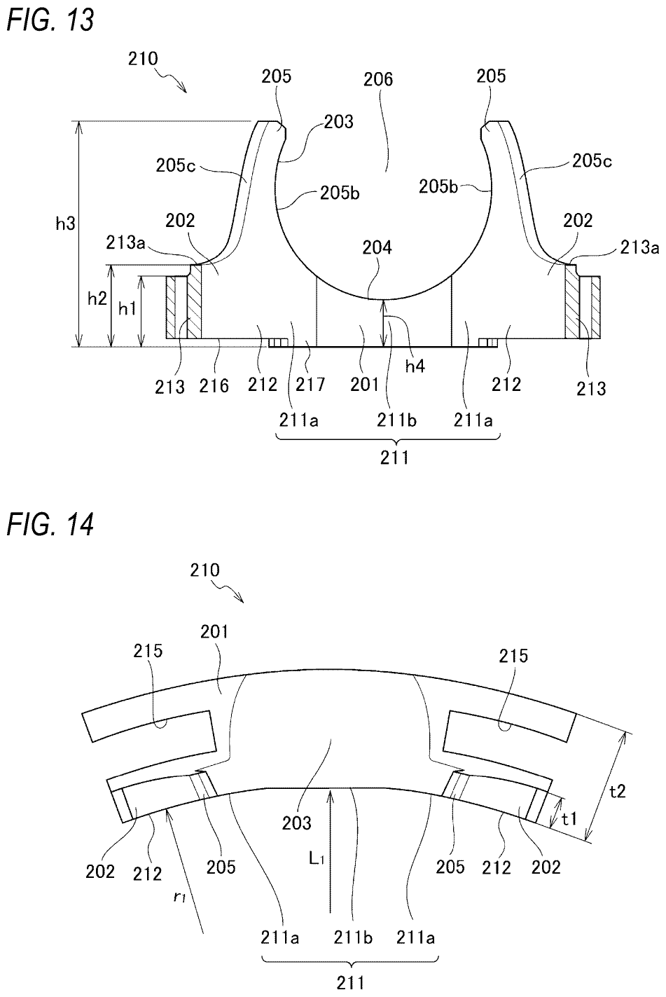

FIG. 11 is a perspective view of the cage according to the third embodiment. FIG. 12 is a top view of the cage according to the third embodiment. FIG. 13 is a view of a portion of the cage according to the third embodiment as viewed from a radially inner side. FIG. 14 is a top view of the portion of the cage according to the third embodiment.

The cage 210 of the present embodiment is different from the cage 210 of the second embodiment (see FIGS. 5 to 10) in that convex portions 217 are provided on a bottom surface 216 of the main portion 201. Since other configurations are the same as those of the second embodiment, the same reference numerals are given to the same components, and description thereof will be omitted or simplified.

The convex portion 217 protrudes from the bottom surface 216 of the main portion 201 in the axial direction (a direction opposite to the direction in which the claw portion 205 extends in an upper-lower direction in FIG. 11) between the opening portions 215, 215 adjacent to each other in the circumferential direction. That is, the bottom surface 216 of the main portion 201 has the plurality of convex portions 217 formed at predetermined intervals in the circumferential direction below the plurality of pockets 203.

A portion of the convex portion 217 preferably overlaps the pocket 203 in the circumferential direction and the radial direction. That is, a circumferential range and a radial range in which the convex portion 217 is provided are preferably substantially the same as a circumferential range and a radial range in which the spherical concave surface 204 of the main portion 201 configuring the pocket 203 is provided. A radial width and a circumferential width of the convex portion 217 of the present embodiment are substantially the same as a radial width (the radial width t2 of the main portion 201) and a circumferential width of the pocket 203.

According to the cage 210 of the third embodiment, the effect of suppressing the stress and the deformation generated by centrifugal force compared to the second embodiment is not significantly different if an axial width h4 of the main portion 201 at a bottom portion of the pocket 203 is the same dimension, but the effect is exerted when the cage 210 is incorporated into the bearing 1 consisting of the inner ring 3, the outer ring 5, and the balls 6. That is, as described later, strain generated in the claw portions 205 of the cage 210 is reduced.

### Modification of Third Embodiment

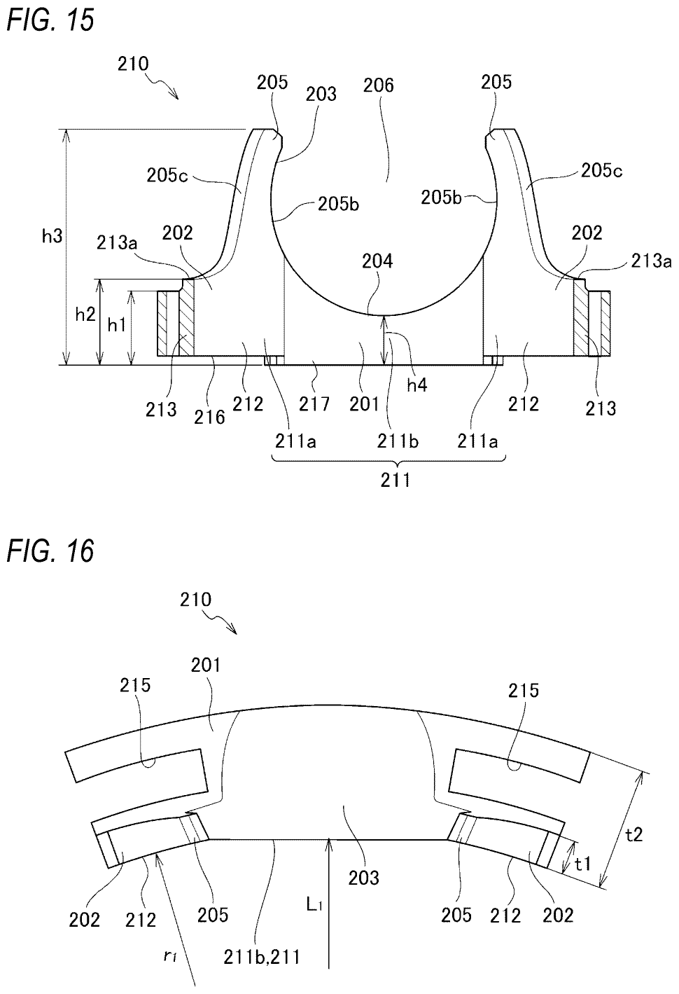

FIG. 15 is a view of a portion of a cage according to a modification of the third embodiment as viewed from a radially inner side. FIG. 16 is a top view of the portion of the cage according to the modification of the third embodiment. As shown in FIGS. 15 and 16, in the present modification, a circumferential width of the convex surface 211b of the inner circumferential surface 211 of the pocket 203 is set larger than that in the example of FIGS. 11 to 14. Specifically, both end portions in the circumferential direction of the convex surface 211b are arranged at substantially the same position in the circumferential direction with respect to tip end portions (inner side end portions in the circumferential direction) of the pair of claw portions 205, 205. Accordingly, the rigidity around the pocket 203 of the cage 210 can be further increased.

### Fourth Embodiment

Next, a crown cage for a ball bearing according to a fourth embodiment of the present invention will be described with reference to the drawings.

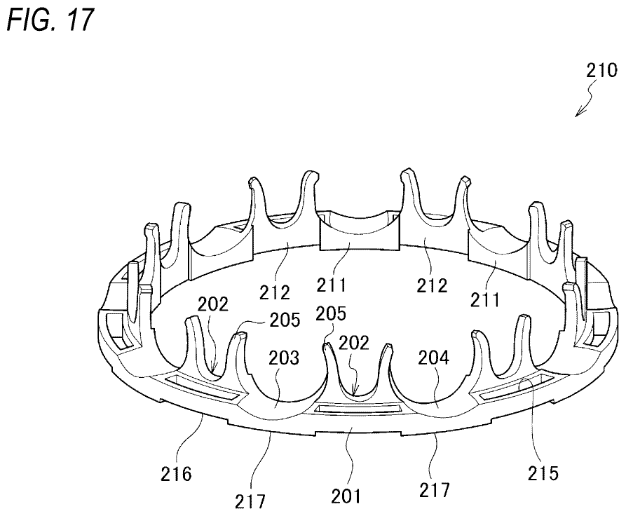

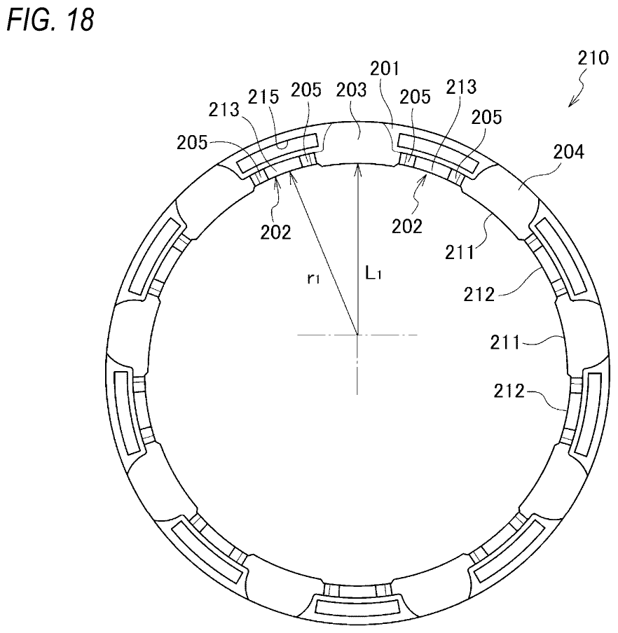

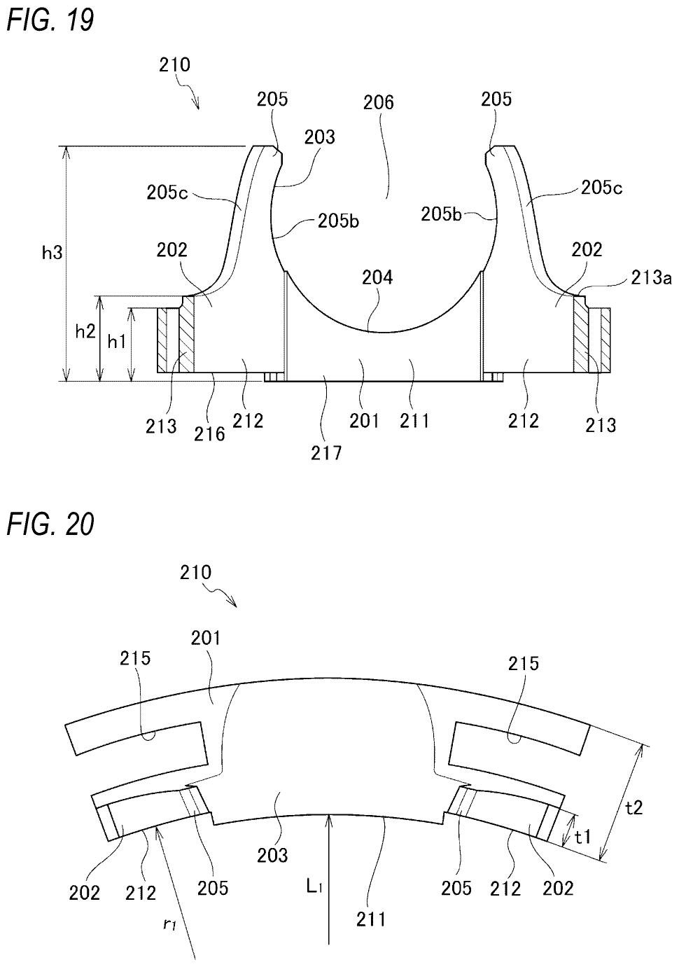

FIG. 17 is a perspective view of the cage according to the fourth embodiment. FIG. 18 is a top view of the cage according to the fourth embodiment. FIG. 19 is a view of a portion of the cage according to the fourth embodiment as viewed from a radially inner side. FIG. 20 is a top view of the portion of the cage according to the fourth embodiment.

A shape of the inner circumferential surface (an inner circumferential surface of the main portion 201 configuring the pocket 203) 211 of the pocket 203 in the cage 210 of the present embodiment is different from a shape thereof in the cage 210 (see FIGS. 11 to 16) of the third embodiment. Since other configurations are the same as those of the third embodiment, the same reference numerals are given to the same components, and description thereof will be omitted or simplified.

In the present embodiment, similarly to the above-described embodiment, the distance L1 from the inner circumferential surface 211 of the pocket 203 to a center of the cage 210 is smaller than the radius r1 of the inner circumferential surface 212 of the pillar portion 202 (L1<r1).

In the illustrated example, the inner circumferential surface 211 of the pocket 203 is a cylindrical surface protruding to the radially inner side from the inner circumferential surface 212 of the pillar portion 202. The distance L1 from the inner circumferential surface 211 of the pocket 203 to the center of the cage 210 (that is, a radius of the inner circumferential surface 211 of the pocket 203) is smaller than the radius r1 of the inner circumferential surface 212 of the pillar portion 202.

According to such a configuration, the rigidity of the pocket 203 is improved, and deformation and stress caused by a centrifugal force during high-speed rotation can be suppressed. As a result, the cage 210 can be prevented from coming into contact with the outer ring 5, the shield plate 7, or the like, and wear, vibration, heat generation, or the like of the cage 210 can be suppressed.

The shape of the inner circumferential surface 211 of the pocket 203 of the present embodiment can be applied not only to the third embodiment but also to the inner circumferential surfaces 111, 211 of the pockets 103, 203 in the cage according to the first and second embodiments.

### Example 1

In order to confirm the effect of the present invention, analysis according to a finite element method was performed. The cage to be analyzed is a resin crown cage used for a bearing having an inner diameter of 35 mm. A shape of the cage was set based on each embodiment of the present invention on the basis of the resin crown cage 100 in the related art and the like.

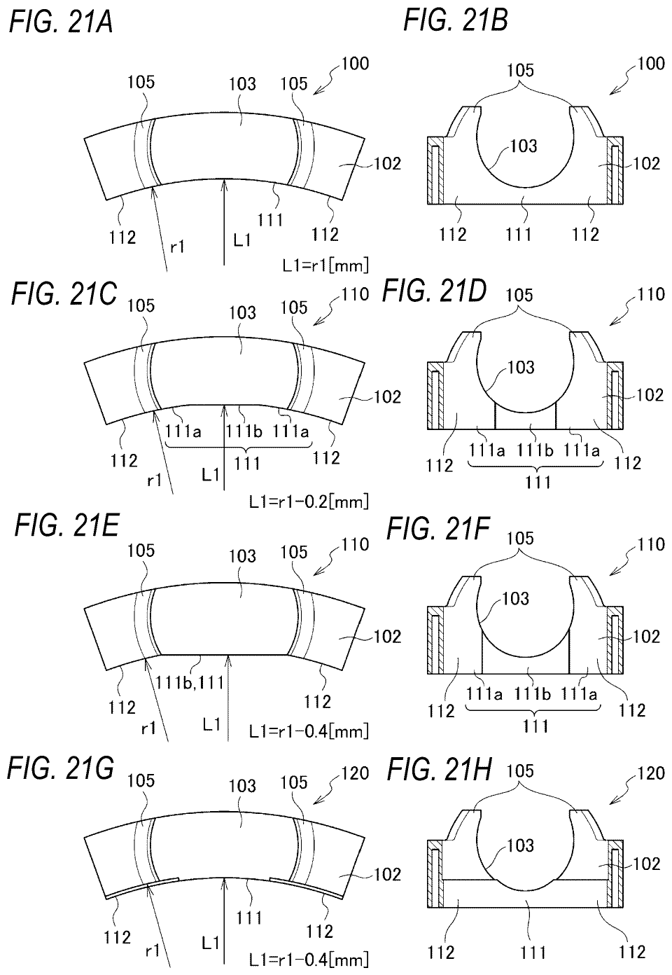

In order to confirm the effect of the first embodiment, shapes of the cages shown in FIGS. 21A to 21H are employed. FIGS. 21A, 21C, 21E, and 21G are top views each showing a portion of a cage, and FIGS. 21B, 21D, 21F and 21H are views each showing the portion of the cage as viewed from the radially inner side. FIGS. 21A and 21B are a comparative example and show the cage 100 shown in FIGS. 31 to 33 as a product in the related art, (FIGS. 21C and 21D are an example and show the cage 110 of the first embodiment shown in FIGS. 1 and 2, FIGS. 21E and 21F are an example and show the cage 110 according to the modification of the first embodiment shown in FIGS. 3 and 4, and FIGS. 21G and 21H show a cage 120 according to a comparative example.

In the cage 120 according to the comparative example of FIGS. 21G and 21H, as compared with the example of FIGS. 21A and 21B, not only the inner circumferential surface 111 of the pocket 103 but also the inner circumferential surface 112 on the main portion side of the pillar portion 102 protrudes to the radially inner side.

The distance L1 from the inner circumferential surface 111 of the pocket 103 to a center of the cage was reduced by 0.2 mm (L1=r1−0.2 mm) in FIGS. 21C and 21D, reduced by 0.4 mm in FIGS. 21E and 21F (L1=r1−0.4 mm), and reduced by 0.4 mm in FIGS. 21G and 21H (L1=r1−0.4 mm) based on the example of FIGS. 21A and 21B (L1=r1).

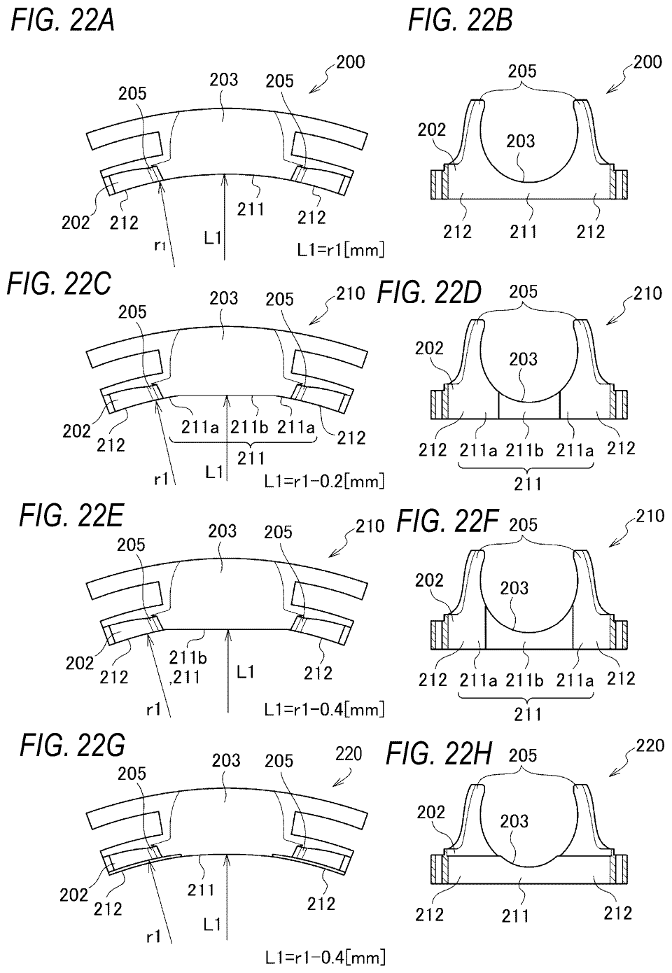

In order to confirm the effect of the second embodiment, shapes of the cages shown in FIGS. 22A to 22H are employed. FIGS. 22A, 22C, 22E, and 22G are top views each showing a portion of a cage, and FIGS. 22B, 22D, 22F and 22H are views each showing the portion of the cage as viewed from the radially inner side. FIGS. 22A and 22B show a cage 200 according to a comparative example, FIGS. 22C and 22D are an example and show the cage 210 according to the second embodiment shown in FIGS. 5 to 8, FIGS. 22E and 22F are an example and show the cage 210 according to the modification of the second embodiment shown in FIGS. 9 and 10, FIGS. 22G and 22H show a cage 220 according to a comparative example.

Different from the examples of FIGS. 22C to 22F, in the cage 200 according to the comparative example of FIGS. 22A and 22B, the distance L1 from the inner circumferential surface 211 of the pocket 203 to the center of the cage is set to be equal to the radius r1 of the inner circumferential surface 212 of the pillar portion 202 (L1=r1).

In the cage 220 according to the comparative example of FIGS. 22G and 22H, as compared with the example of FIGS. 22A and 22B, not only the inner circumferential surface 211 of the pocket 203 but also the inner circumferential surface 212 on the main portion side of the pillar portion 202 protrudes to the radially inner side.

The distance L1 from the inner circumferential surface 211 of the pocket 203 to a center of the cage was reduced by 0.2 mm (L1=r1−0.2 mm) in FIGS. 22C and 22D, reduced by 0.4 mm in FIGS. 22E and 22F (L1=r1−0.4 mm), and reduced by 0.4 mm in FIGS. 22G and 22H (L1=r1−0.4 mm) based on the example of FIGS. 22A and 22B (L1=r1).

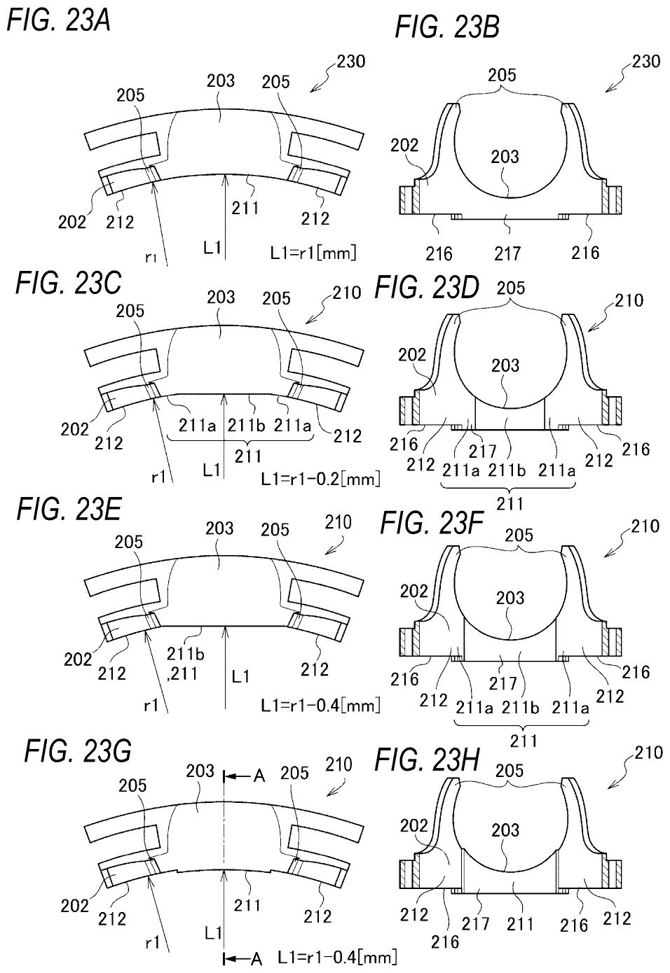

In order to confirm the effects of the third and fourth embodiments, shapes of the cages shown in FIGS. 23A to 23H are employed. FIGS. 23A, 23C, 23E, and 23G are top views each showing a portion of a cage, and FIGS. 23B, 23D, 23F and 23H are views each showing the portion of the cage as viewed from the radially inner side. FIGS. 23A and 23B show a cage 230 according to a comparative example, FIGS. 23C and 23D are an example and show the cage 210 according to the third embodiment shown in FIGS. 11 to 14, FIGS. 23E and 23F are an example and show the cage 210 according to the modification of the third embodiment shown in FIGS. 15 and 16, and FIGS. 23G and 23H are an example and show the cage 210 according to the fourth embodiment shown in FIGS. 17 to 20.

Different from the examples of FIGS. 23C to 23F, in the cage 230 according to the comparative example of FIGS. 23A and 23B, the distance L1 from the inner circumferential surface 211 of the pocket 203 to the center of the cage is set to be equal to the radius r1 of the inner circumferential surface 212 of the pillar portion 202 (L1=r1).

The distance L1 from the inner circumferential surface 211 of the pocket 203 to a center of the cage was reduced by 0.2 mm (L1=r1−0.2 mm) in FIGS. 23C and 23D, reduced by 0.4 mm in FIGS. 23E and 23F (L1=r1−0.4 mm), and reduced by 0.4 mm in FIGS. 23G and 23H (L1=r1−0.4 mm) based on the example of FIGS. 23A and 23B (L1=r1).

Dimensions of each cage were set such that the inner circumferential radius r1 of the cage (the radius of the inner circumferential surface 212 of the pillar portion 202) was 24.5 mm and a height in the axial direction was 10 mm. Material property values of each cage were a Young's modulus of 7210 MPa, a Poisson's ratio of 0.4, and a density of 1.27 g/cm³. As conditions, a rotation speed of the cage was 15,000 rpm when a rotation speed of the inner ring (rotating ring) was 38,000 rpm.

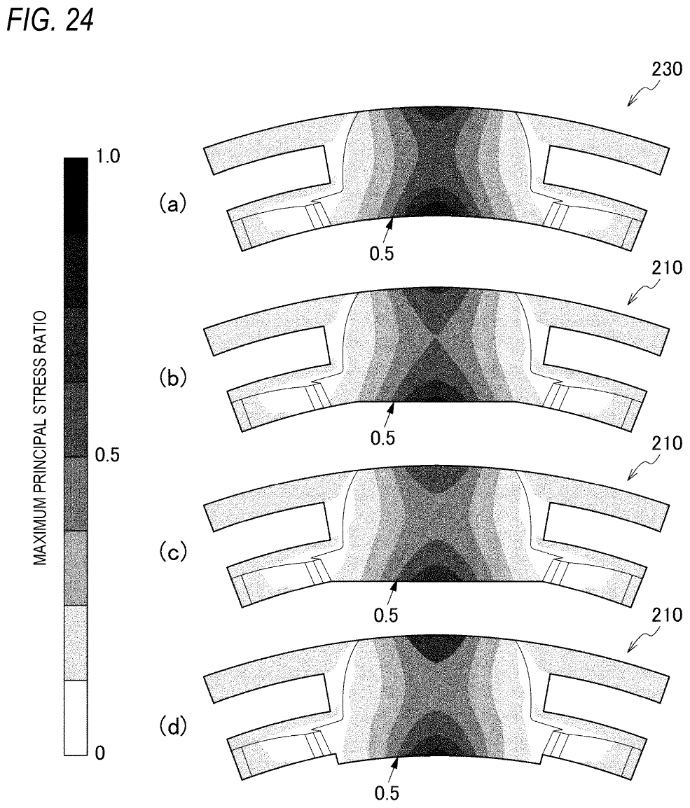

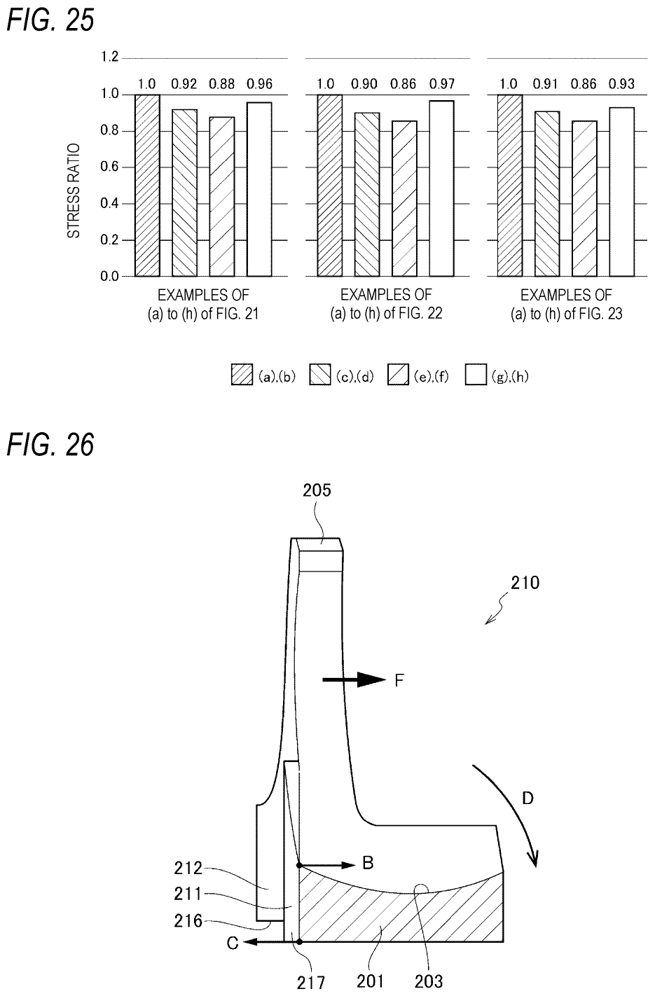

Sections (a) to (d) of FIG. 24 show a maximum principal stress distribution generated in the cages by the centrifugal force. The cages shown in Sections (a) to (d) of FIG. 24 correspond to the cages shown in FIGS. 23A, 23C, 23E, and 23G, respectively. Here, a stress value was a relative value.

It can be seen that a largest stress is generated in the cage 230 of the comparative example of Section (a) of FIG. 24. On the other hand, it can be seen that in the cages 210 of Sections (b), (c), and (d) of FIG. 24, the generation of stress is suppressed as compared with the cage 230 of Section (a) of FIG. 24.

FIG. 25 shows results of relative comparison of a maximum value of a maximum principal stress generated by a centrifugal force in each cage shown in FIGS. 21A to 23H.

In the examples of FIGS. 21A to 21H in FIG. 25, the maximum value of the maximum principal stress generated in the cage 100 according to the example in the related art shown in FIGS. 21A and 21B is set to 1.0, and a ratio of the maximum value of the maximum principal stress generated in each of the cages 110 shown in FIGS. 21C to 21H is shown. As shown in FIGS. 21C to 21F, when only the pocket 103 is thickened to the radially inner side, the stress ratios become 0.92 and 0.88, respectively, which shows that the stress is reduced. On the other hand, as shown in FIGS. 21G and 21H, when the entire inner circumference of the cage 120 is thickened, the stress ratio becomes 0.96, which shows that there is little effect.

In the examples of FIGS. 22A to 22H in FIG. 25, the maximum value of the maximum principal stress generated in the cage 200 according to the comparative example shown in FIGS. 22A and 22B is set to 1.0, and a ratio of the maximum value of the maximum principal stress generated in each of the cages 210, 220 shown in FIGS. 22C to 22H is illustrated. As shown in FIGS. 22C to 22F, when only the pocket 203 is thickened in the radially inner side, the stress ratios become 0.90 and 0.86, respectively, which shows that the stress is lower than when the entire inner circumference of the cage 220 is thickened as shown in FIGS. 22G and 22H (stress ratio: 0.97).

In the examples of FIGS. 23A to 23H in FIG. 25, the maximum value of the maximum principal stress generated in the cage 230 according to the comparative example shown in 23A and 23B is set to 1.0, and a ratio of the maximum value of the maximum principal stress generated in each of the cages 210 shown in FIGS. 23C to 23H is illustrated. As shown in FIGS. 23C to 23H, when only the pocket 203 is thickened in the radially inner side, the stress ratios become 0.91, 0.86, and 0.93, respectively, which shows that there is a stress reduction effect.

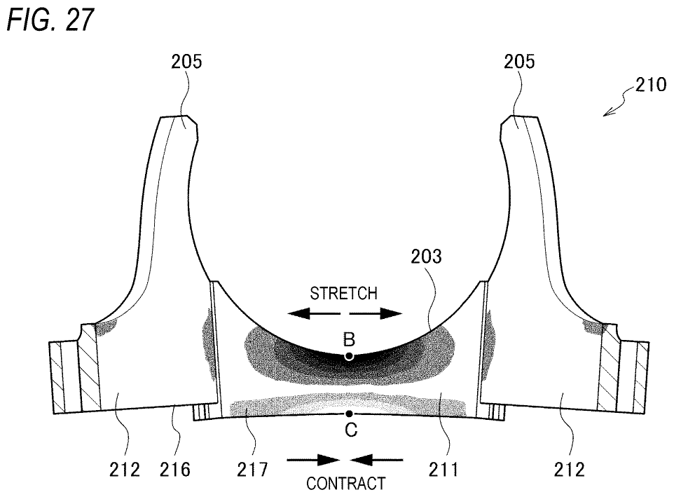

Here, the stress when the centrifugal force is applied to the cage 210 will be described using the example of FIGS. 23G and 23H (fourth embodiment). FIG. 26 is a cross-sectional view taken along a line A-A of FIG. 23G. FIG. 27 shows a stress distribution when a centrifugal force is applied in the example of FIG. 23H.
In FIG. 27, the deformation of the cage is exaggerated for about 10 times.

As shown in FIG. 26, when a centrifugal force F is applied to the cage 210, the claw portion 205 falls toward a direction of an arrow D in FIG. 26 with the annular main portion 201 as a center. Therefore, a point B on an inner diameter side of the pocket 203 moves to the radially outer side, and a point C moves to the radially inner side. Then, as shown in FIG. 27, the point B extends in the circumferential direction, and the point C contracts in the circumferential direction. Since the thickness of the bottom portion of the pocket 203 is the thinnest, the highest tensile stress in the circumferential direction is generated in the portion of the point B. Since the larger a cross-sectional area of the thinnest part of the bottom of the pocket 203, the less likely the claw portion 205 falls, the stress in the examples of FIGS. 23C to 23H can be reduced as compared to the example of FIGS. 23A and 23B. In the example of FIGS. 23G and 23H, although the volume of the main portion 201 is slightly larger than those in the examples of FIGS. 23C to 23F, a larger centrifugal force is applied, and a stress (stress ratio: 0.93) higher than those in the examples of FIGS. 23C to 23F (stress ratio: 0.91, 0.86) is generated.

Similarly, in the example of FIGS. 21G and 21H, since the volume of the main portion 101 is larger than those in the examples of FIGS. 21C to 21F, a larger centrifugal force is applied, and a stress (stress ratio: 0.96) higher than those in the examples of FIGS. 21C to 21F (stress ratio: 0.92, 0.88) is generated.

Similarly, in the example of FIGS. 22G and 22H, since the volume of the main portion 201 is larger than those in the examples of FIGS. 22C to 22F, a larger centrifugal force is applied, and a stress (stress ratio: 0.97) higher than those in the examples of FIGS. 21C to 21F (stress ratio: 0.90, 0.86) is generated.

### Example 2

The strain generated in the claw portion 205 when the cage 210 having no convex portion 217 on the bottom surface 216 of the main portion 201 and the cage 210 having the convex portions 217 on the bottom surface 216 of the main portion 201 are incorporated into the bearing 1 including the inner ring 3, the outer ring 5, and the balls 6 is analyzed by the finite element method and calculated.

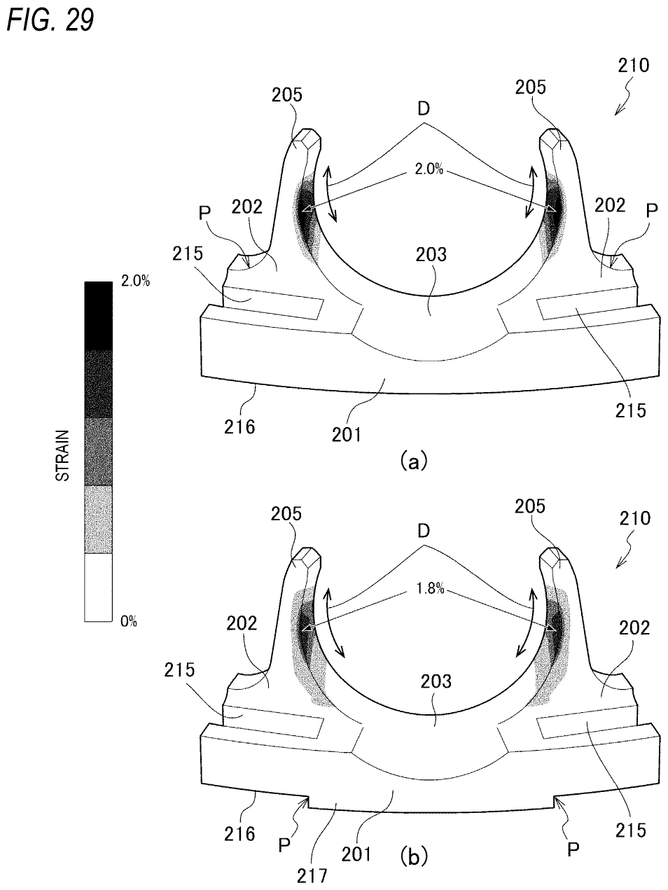

Sections (a) and (b) of FIG. 29 are analysis results of a strain distribution of the cages. The cage 210 of Section (a) of FIG. 29 is the cage according to the modification of the second embodiment shown in FIGS. 9 and 10, and does not have the convex portions 217 on the bottom surface 216 of the main portion 201. The cage 210 of Section (b) of FIG. 29 is the cage according to the modification of the third embodiment shown in FIG. 15 and FIG. 16, and has the convex portions 217 on the bottom surface 216 of the main portion 201.

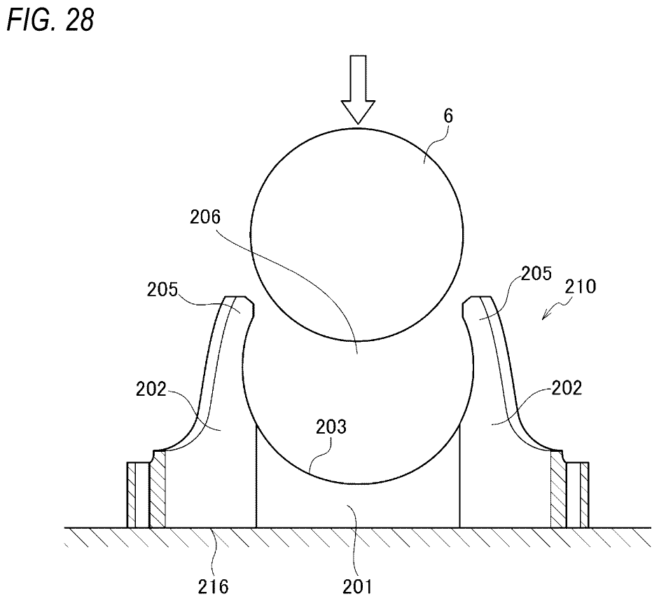

In the analysis, as shown in FIG. 28, the model in which one portion of the cage 210 was taken out and the ball 6 was pushed little by little was used. In actual bearing assembly, the ball is fixed and the cage is moved, but in the present analysis, the model in which the cage is fixed and the ball is moved is used since an overall movement remains the same. The strain distribution when the strain becomes maximum at this time is shown in Sections (a) and (b) of FIG. 29.

The maximum value of the strain generated in the claw portion 205 of the cage 210 of Section (a) of FIG. 29 was 2.0%. On the other hand, the maximum value of strain generated in the claw portion 205 of the cage 210 in (b) of FIG. 29 is 1.8%, which is 10% lower than the example in Section (a) of FIG. 29, which shows that providing the convex portions 217 has a strain reduction effect.

This is because, as shown in Sections (a) and (b) of FIG. 29, when the ball 6 is pushed into the pocket 203 of the cage 210, the claw portion 205 is widened in the circumferential direction with a portion having low rigidity as a fulcrum P. That is, it is considered that the farther the fulcrum P is positioned from the tip end portion of the claw portion 205, the wider a strain generation region D, and since the generated strain is dispersed, the maximum value is reduced.

In the cage 210 according to the modification of the third embodiment shown in Section (b) of FIG. 29 compared with the cage 210 according to the modification of the second embodiment shown in Section (a) of FIG. 29, the strain generation region D is widened and the maximum value of the strain is further reduced as a distance from the tip end portion of the claw portion 205 to the fulcrum P increases.

When the present invention is applied to a cage using a resin material such as polyamide 9T (PA9T) or polyamide 10T (PA10T) having a smaller elongation than nylon 46 or nylon 66, strain can be reduced.

The present specification discloses the following contents.

(1) A crown cage for a ball bearing includes:
an annular main portion;
a plurality of pillar portions protruding in an axial direction at predetermined intervals in a circumferential direction from the main portion; and
a pocket formed between the adjacent pillar portions and having a spherical concave surface having a spherical shape capable of holding a ball, wherein
the pillar portion includes a pair of claw portions having tip end portions arranged at intervals therebetween and a connection portion connecting the pair of claw portions,
an inlet portion having a width shorter than a diameter of the ball and for inserting the ball is provided between the tip end portions of the two adjacent claw portions configuring the pocket, and
a distance from an inner circumferential surface of the pocket to a center of the crown cage for a ball bearing is smaller than a radius of an inner circumferential surface of the pillar portion.

(2) The crown cage for a ball bearing according to (1), in which
a convex portion protruding in the axial direction is provided on a bottom surface of the main portion, and
at least a portion of the convex portion overlaps the pocket in the circumferential direction and a radial direction.

(3) The crown cage for a ball bearing according to (1) or (2), in which
the claw portion protrudes in the axial direction from a radially inner side portion of an upper surface of the main portion, and
the upper surface of the main portion is exposed to a radially outer side of the pillar portion.

(4) The crown cage for a ball bearing according to (3), in which
an opening portion opened in the axial direction is provided between the adjacent pockets in the main portion.

(5) The crown cage for a ball bearing according to any one of (1) to (4), in which
the inner circumferential surface of the pocket is a cylindrical surface protruding to a radially inner side from the inner circumferential surface of the pillar portion.

(6) A ball bearing includes:
an outer ring;
an inner ring;
a plurality of balls arranged between the outer ring and the inner ring; and
the crown cage for a ball bearing according to any one of (1) to (5).

Although various embodiments have been described above with reference to the drawings, the present invention is not limited to these examples. It is apparent to those skilled in the art that various variations or modifications can be conceived within the scope described in the claims, and it is understood that the variations or modifications naturally fall within the technical scope of the present invention. In addition, the components in the above embodiments may be combined in any manner within the scope not departing from the gist of the invention.

The present application is based on a Japanese Patent Application (No. 2022-069471) filed on Apr. 20, 2022, the contents of which are incorporated herein by reference.

### REFERENCE SIGNS LIST

1 ball bearing
2 inner ring raceway
3 inner ring
4 outer ring raceway
5 outer ring
6 ball
7 shield plate
100, 110, 120 cage
101 main portion
102 pillar portion
103 pocket
104 spherical concave surface
105 claw portion
106 inlet portion
111 inner circumferential surface of pocket
111a connection surface
111b convex surface
112 inner circumferential surface of pillar portion
113 connection portion
201 main portion
202 pillar portion
203 pocket
204 spherical concave surface
205 claw portion
205b circumferential first surface
205c circumferential second surface
206 inlet portion
200, 210, 220, 230 cage
211 inner circumferential surface of pocket
211a connection surface
211b convex surface
212 inner circumferential surface of pillar portion
213 connection portion
213a upper surface
215 opening portion
216 bottom surface
217 convex portion

1. A crown cage for a ball bearing comprising:
an annular main portion;
a plurality of pillar portions protruding in an axial direction at predetermined intervals in a circumferential direction from the main portion; and
a pocket formed between the adjacent pillar portions and having a spherical concave surface having a spherical shape capable of holding a ball, wherein:
the pillar portion includes a pair of claw portions having tip end portions arranged at intervals therebetween and a connection portion connecting the pair of claw portions;
an inlet portion having a width shorter than a diameter of the ball and for inserting the ball is provided between the tip end portions of the two adjacent claw portions configuring the pocket; and
a distance from an inner circumferential surface of the pocket to a center of the crown cage for a ball bearing is smaller than a radius of an inner circumferential surface of the pillar portion.

2. The crown cage for a ball bearing according to claim 1, wherein:
a convex portion protruding in the axial direction is provided on a bottom surface of the main portion; and
at least a portion of the convex portion overlaps the pocket in the circumferential direction and a radial direction.

3. The crown cage for a ball bearing according to claim 1, wherein:
the claw portion protrudes in the axial direction from a radially inner side portion of an upper surface of the main portion; and
the upper surface of the main portion is exposed to a radially outer side of the pillar portion.

4. The crown cage for a ball bearing according to claim 3, wherein
an opening portion opened in the axial direction is provided between the adjacent pockets in the main portion.

5. The crown cage for a ball bearing according to claim 1, wherein
the inner circumferential surface of the pocket is a cylindrical surface protruding to a radially inner side from the inner circumferential surface of the pillar portion.

6. A ball bearing comprising:
an outer ring;
an inner ring;
a plurality of balls arranged between the outer ring and the inner ring; and
the crown cage for a ball bearing according to claim 1.
